(19) United States
(12) Patent Application Publication
(10) Pub. No.: US 2010/0074711 A1
(43) Pub. Date: Mar. 25, 2010

(54) FINELY ADJUSTABLE ADJUSTING SCREW ARRANGEMENT WITH ARRESTING MEANS AND PLAIN BEARING WITH BEARING PLAY ADJUSTMENT

(75) Inventor: Horst Moshammer, Linz am Rhein (DE)

Correspondence Address: GROSSMAN, TUCKER, PERREAULT & PFLEGER, PLLC, 55 SOUTH COMMERICAL STREET, MANCHESTER, NH, 03101, US

(73) Assignee: IGUS GMBH, Koln (DE)

(21) Appl. No.: 12/563,272

(22) Filed: Sep. 21, 2009

(30) Foreign Application Priority Data
Sep. 19, 2008 (DE) 20 2008 012 504.9

(51) Int. Cl. F16B 39/284; F16C 29/12

(52) U.S. Cl. 411/324; 384/40

(57) ABSTRACT

An adjusting screw arrangement comprising an adjusting screw (8) and a screwthread receiving means in which the adjusting screw (8) is displaceable in the axial direction by rotation, for providing a self-arresting action and for avoiding a lock nut and an anti-slackening securing means, has a toothed ring (10) connected to the adjusting screw (8) on the same axis, and a coil spring (11) which is arranged substantially perpendicularly to the axis of the adjusting screw, wherein at least one end of the coil spring (11) is fixed so that the turns thereof mesh with the teeth of the toothed ring (10).

The present invention concerns an adjusting screw arrangement which is very finely adjustable and is provided with an automatic arresting means.

Adjusting screws are used in many situations to fix the geometrical relationship of two articles or the geometrical relationship of two mutually movable portions of an item of equipment.

Examples of the use of adjusting screws are bearing play adjustments for axial or linear displacement bearings as well as adjusting and fine adjusting devices on mechanical, hydraulic, electrical and electronic devices and measuring units.

Adjusting screws can be subjected either to a compression loading or a tensile loading. Adjusting screws subjected to a compression loading are designed for spreading the spacing of the portions which are to be adjusted relative to each other. They define a minimum spacing of the portions. The one portion contains the nut for the adjusting screw and the other portion (counterpart portion) carries the pressure of the contact part of the adjusting screw. Portions which are subjected to a tensile loading are designed for reducing the spacing of the portions to be adjusted. They define a maximum spacing for the portions. The one portion contains the nut for the adjusting screw and the other portion (counterpart portion) has a through bore, through which the adjusting screw passes, wherein the head of the adjusting screw carries the tensile force on the side of the counterpart portion, that is remote from the portion containing the nut.

In general releasable fixing of a position, once set, of an adjusting screw is effected by means of lock nuts. On the one hand that requires complicated and laborious manipulation operation as, to tighten the lock nut, the adjusting screw has to be held to prevent it from turning and on the other hand this involves structural limitations as both the adjusting screw and also the lock nut must be accessible for actuation by means of tools from outside the article or the fitment. Additional anti-slackening securing means may possibly be required for the lock nut.

The present invention provides an adjusting screw arrangement which is self-arresting and therefore manages without a lock nut and an anti-slackening securing means and therefore also permits novel structural options in regard to the articles, devices and fitments, in which it is used.

The subject-matter of the invention is an adjusting screw arrangement comprising an adjusting screw and a screwthread receiving means in which the adjusting screw is displaceable in the axial direction by rotation, characterized by a toothed ring connected to the adjusting screw on the same axis, and a coil spring which is arranged substantially perpendicularly to the axis of the adjusting screw, and wherein at least one end of the coil spring is fixed so that the turns thereof mesh with the teeth of the toothed ring.

Preferably both ends of the coil spring are fixed.

Fixing of the coil spring can be effected by pins which project into the coil spring or by receiving mountings for the ends of the coil spring, which prevent axial movement and a movement parallel and away from the axis of the adjusting screw. Two flat contact surfaces which extend inclinedly relative to the cross-sectional plane of the toothed ring are adequate as receiving mountings for the ends of the coil spring. In that case fixing of the coil spring can be effected in such a way that it bears under a prestressing against the toothed ring.

Fixing of the coil spring can be effected in relation to the portion containing the nut or the counterpart portion. If fixing is effected on the portion containing the nut, the extent of the toothed ring in the axial direction thereof should correspond at least to the maximum intended stroke movement of the adjusting screw. If on the other hand only an adjustment in the range of less than one pitch of the adjusting screw per turn is required the toothed ring can be in the form of a ring portion.

Provided at the side of the coil spring, that is opposite to the toothed ring, in the central region of the coil spring, is a free space into which the coil spring can be transversely deformed.

The toothed ring can be integrally formed on the adjusting screw. It can also be mounted to the adjusting screw in non-rotational relationship therewith by other means.

The turns spacing of the coil spring is preferably so selected that it approximately corresponds to the tooth arrangement of the toothed ring.

The coil spring can be of a cylindrical, frustoconical-like or bellied-out configuration.

The adjusting screw is secured to prevent unintentional rotation thereof, that is to say to prevent the arrangement moving out of adjustment, by the engagement of the turn of the coil spring into the tooth arrangement of the toothed ring.

Upon actuation of the adjusting screw the toothed ring connected thereto applies a pressure to the coil spring, which provides that the coil spring is elastically deformed transversely away from the toothed ring so that the toothed ring latches further by a respective tooth into the adjacent turn of the coil spring. Adjustment of the adjusting screw arrangement is therefore effected stepwise, in which case the adjustment accuracy, that is to say the stroke movement of the adjusting screw per adjusting step, derives from the pitch per turn of the adjusting screw divided by the number of teeth of the tooth arrangement.

The required torque for actuation of the adjusting screw is dependent on the stiffness of the coil spring and the steepness and depth of the teeth of the toothed ring as well as the prestressing with which the spring bears against the toothed ring.

A slight and therefore sensitive torque with a high level of adjustment accuracy is preferred. That can be implemented by rounded-off teeth with a shallow tooth arrangement in the manner of a knurling. Preferably the flanks of the teeth of the toothed ring form an angle of between 50 and 70° with the central plane containing the axis of the toothed ring, between two teeth.

The adjusting screw arrangement according to the invention is preferably used in play adjustment for plain bearings. With such systems, a slide housing slides on a guide rail which is round or angular in cross-section and which is embraced by the housing over an angular range of between 250 and 300°. The inside surface of the slide housing is equipped with a polymer housing bearing. Preferably the housing bearing has a bearing block which represents between about 70 and 100° of the envelopment of the guide rail by the housing bearing. In accordance with the invention an adjusting screw acts on that bearing block for play adjustment.

The subject-matter of the invention is also a plain bearing arrangement which has at least one guide rail, with a slide housing, whose surface that is towards the guide rail has a housing bearing with a bearing block, and an adjusting screw acting on the bearing block for adjustment of the bearing play, which is characterized in that the adjusting screw has a toothed ring non-rotatably connected to the adjusting screw on the same axis and in addition a coil spring is arranged in the slide housing substantially perpendicularly to the axis of the adjusting screw, wherein at least one end of the coil spring is fixed so that the turns thereof mesh with the teeth of the toothed ring.

Further advantageous configurations of the plain bearing arrangement according to the invention will be apparent from the foregoing description of the adjusting screw arrangement according to the invention and the following Figures.

The same references in the Figures denote the same components.

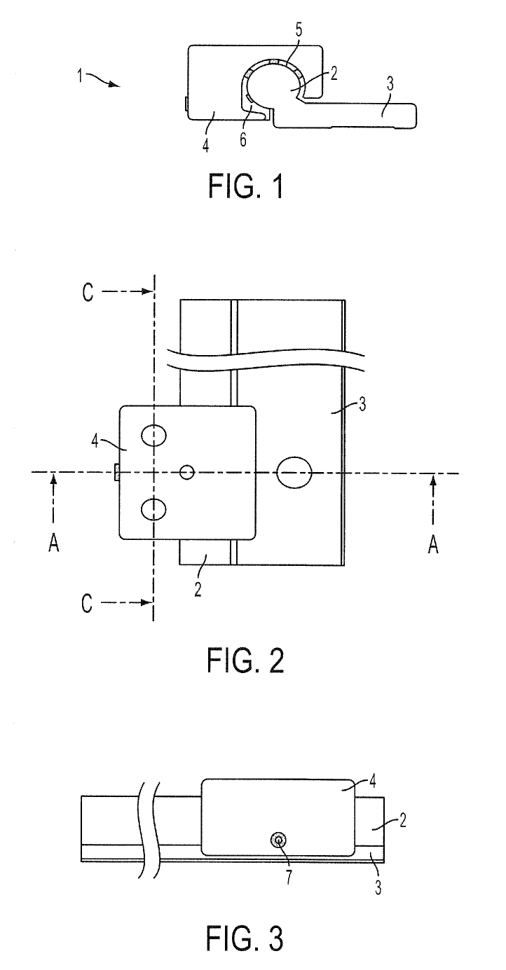

FIG. 1 shows a plain bearing arrangement 1 viewing in the direction of the plain bearing slide rail 2 which has a connecting portion 3 serving for fastening the slide rail on a flat surface. The slide housing 4 slides on the slide rail 2. Provided on the inside surface of the slide housing 4 is the plain bearing 5 which is in the form of a plain bearing slide film provided with strips in the longitudinal direction and which further has the bearing block 6.

FIG. 2 shows a plan view of the plain bearing arrangement of FIG. 1.

FIG. 3 shows a side view of the plain bearing arrangement of FIG. 1, wherein the actuating head 7 of the adjusting screw which can be in the form of a hexagonal socket can be seen there.

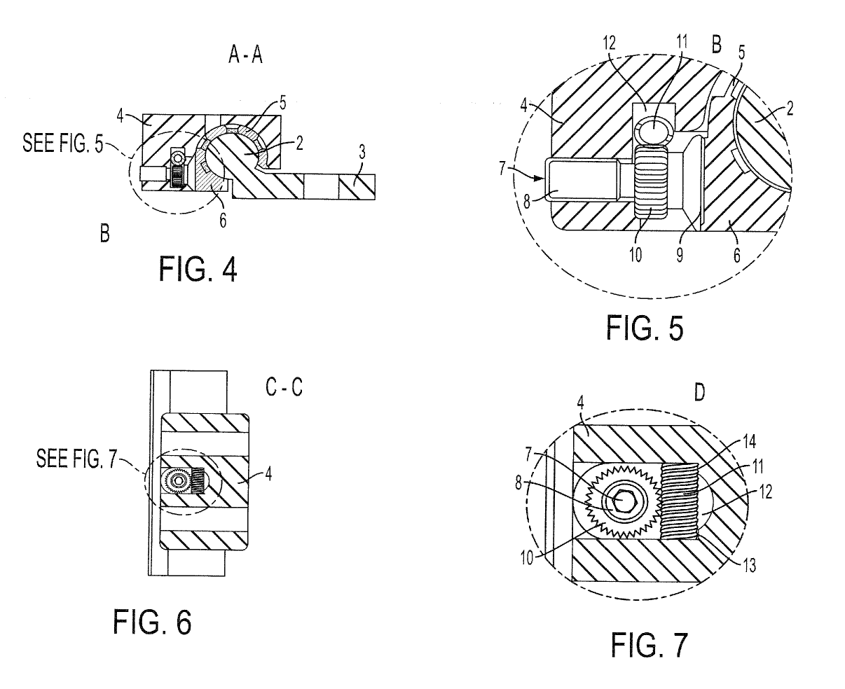

FIG. 4 shows a section A-A from FIG. 2.

FIG. 5 shows a detail portion B on an enlarged scale from FIG. 4. The adjusting screw 8 acts with its contact surface 9 on the bearing block 6. The toothed ring 10 is non-rotatably connected to the adjusting screw 8. Above the toothed ring 10 it is possible to see the coil spring 11, the axis of which extends perpendicularly to the plane of the drawing and which engages with its central turns into the teeth of the toothed ring 10. A free space 12 is cut out on the side of the coil spring 11, that is remote from the toothed ring 10.

FIG. 6 shows a section C-C in FIG. 2 through the slide housing 4.

FIG. 7 shows a detail portion D on an enlarged scale from FIG. 6. The coil spring 11 engaging into the teeth of the toothed ring 10 is fixed with its ends at the shoulders 13, 14. Upon actuation of the adjusting screw 8 the central region of the coil spring 11 bends elastically transversally with respect to its axis into the free space 12 so that its turns which are in engagement slide over the corresponding teeth of the toothed ring 10 and come into latching engagement between the next teeth. The fact of overcoming the latching resistance can be clearly felt by the person actuating the arrangement, thus permitting precise adjustment of the bearing play. At the same time the adjusting screw 8 is secured to prevent unintentional displacement thereof by virtue of engagement of the coil spring 11 into the toothed ring 10.

### LIST OF REFERENCES

1 plain bearing arrangement

2 slide rail

3 connecting portion

4 slide housing

5 plain bearing

6 bearing block

7 actuating head

8 adjusting screw

9 contact surface

10 toothed ring

11 coil spring

12 free space

13 shoulder

14 shoulder

1. An adjusting screw arrangement comprising an adjusting screw and a screwthread receiving means in which the adjusting screw is displaceable in the axial direction by rotation, characterized by a toothed ring connected to the adjusting screw on the same axis, and a coil spring which is arranged substantially perpendicularly to the axis of the adjusting screw, and wherein at least one end of the coil spring is fixed so that the turns thereof mesh with the teeth of the toothed ring.

2. An adjusting screw arrangement as set forth in claim 1 wherein the coil spring is fixed at both ends.

3. An adjusting screw arrangement as set forth in claim 1 wherein provided at the side of the coil spring, that is opposite to the toothed ring, is a free space into which the coil spring can be transversely deformed.

4. An adjusting screw arrangement as set forth in claim 1 wherein the teeth of the toothed ring are rounded-off.

5. An adjusting screw arrangement as set forth in claim 1 wherein the flanks of the teeth of the toothed ring form an angle of between 50 and 70° with the central plane containing the axis of the toothed ring, between two teeth.

6. A plain bearing arrangement which has at least one guide rail, with a slide housing, whose surface that is towards the guide rail has a housing bearing with a bearing block, and an adjusting screw acting on the bearing block for adjustment of the bearing play, characterized in that the adjusting screw has a toothed ring non-rotatably connected to the adjusting screw on the same axis and in addition a coil spring is arranged in the slide housing substantially perpendicularly to the axis of the adjusting screw, wherein at least one end of the coil spring is fixed so that the turns thereof mesh with the teeth of the toothed ring.
